(19) United States
(12) Patent Application Publication
(10) Pub. No.: US 2002/0184313 A1
(43) Pub. Date: Dec. 5, 2002

(54) Method for exchange of data and user interface components

(75) Inventors: Thierry Bedos, Singapore (SG); Teck Peng. Jaric Sng, Singapore (SG); Boon Khuan Tan, Singapore (SG)

Correspondence Address: MERCHANT & GOULD PC, P.O. BOX 2903, MINNEAPOLIS, MN, 55402-0903, US

(73) Assignee: Nexusedge Technologies PTE LTD

(21) Appl. No.: 09/871,861

(22) Filed: Jun. 1, 2001

(51) Int. Cl. G06F 15/16; G09G 5/00

(52) U.S. Cl. 709/205; 345/758

(57) ABSTRACT

1. A method for exchange of data and user interface components over a network, the method including the steps of:

(a) enabling a first user to logon to a server;

(b) enabling the first user to create a message containing a data object;

(c) receiving from the first user the message together with an identity of at least one second user to whom the message is to be sent;

(d) sending the message to the second user upon the second user logging on to the server; and

(e) enabling both the first user and the second user to substantially simultaneously open and view the message including the data object.

### REFERENCE TO RELATED APPLICATIONS

Reference is made to our earlier U.S. patent application Ser. No. 09/801,150 filed Mar. 7, 2001 for an invention entitled “Software Engine and Method for Software Application Loading”, the contents of which are hereby incorporated by reference. That earlier application relates to a loading engine for the prioritizing and loading of data. It is the preferred download system for the present invention.

### FIELD OF INVENTION

The present invention relates to a system and method for users connected to a server through a network to exchange information and graphical user interface components through the network and the server.

### BACKGROUND TO THE PRESENT INVENTION

The present method of sending data between two remote terminals is to send the data as an email, or as an attachment to an email. The receiver opens the email (and the attachment, is necessary) and can study the data If they have comments on the data, they send an email in reply outlining their comments. Alternatively, they can save the data, amend it, and resend it to the original sender. This can take considerable time, and may require many commands by each party at their machine. With large data files, the delays can be sufficient to cause interference with the normal operation of a business.

Chat-room communication Systems such as, for example, ICQ, cannot cope with large data files, such as the data files normally used in business.

It is therefore the principal object of the present invention to provide a method for the exchange of data, and user interface components.

### SUMMARY OF THE INVENTION

Given a server connected to a network, for example the Internet, and clients connected to a server through the network and executing a client application, the method disclosed enables a channel of communication to be opened between the client applications via the server.

Users interacting with the client application can exchange messages, as is currently the case with chat applications, or documents located on their local machine or on the server. Moreover, they can exchange all or part of user interfaces (which may contain data) between them in such a manner that, when a user shares a user interface component with one or more other users, the user interface component (and any data it contains) appears simultaneously on the applications of all the users.

When user interface components are shared on different users machines, user interactions on the interface components can be shared between the clients who can see the user interface component, and any data it contains. Any amendment, change, or the like, to the data by one user will be effected simultaneously (or as near as simultaneous as the network will allow) on all user applications.

### DESCRIPTION OF DRAWINGS

In order that the invention may be clearly understood and readily put into practical effect, there shall now be described by way of non-limitative example only a preferred embodiment of the present invention, the description being with reference to the accompanying illustrative drawings in which:

FIG. 1 is an example of a system architecture;

FIG. 2 is an overview of the operation of the present invention;

FIG. 3 is an illustration of the server's functionality in dealing with different message categories;

FIG. 4 is a flow chart representing the principal steps in the operation of the preferred embodiment, when sending;

FIG. 5 is a flow chart corresponding to FIG. 4 but when receiving; and

FIG. 6 is a flow chart from the server side.

### DESCRIPTION OF PREFERRED EMBODIMENT

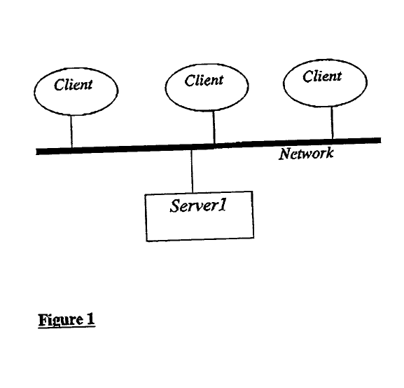

As shown in FIG. 1, there are a number of registered users/clients connected to each other, and to a server, by a network. The network may be the Internet and/or one or more intranet networks. All client machines are connected to the network using a client application such as, for example, a Java applet operating in an Internet browser. The client applications are connected to the server. All users for the present system are registered with the server. If a registered user attempts to use the server to send a message to an unregistered user, the server will require the receiver to be registered before sending the message to the receiver.

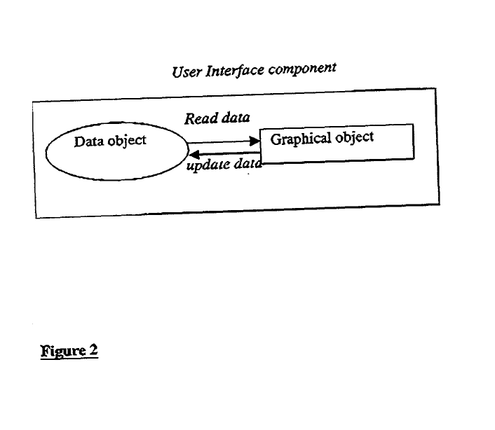

To now refer to FIG. 2, the client application is an application that contains a user interface, which may be written in the Java programming language. The client application has means to enable it to be uniquely identified by the server. This means can be the use of a unique identifier (for instance, the unique identifier of the user that is currently running the application), or may use any other relevant or known method.

The user interface of the application is composed of different graphic user interfaces (“GUI”s), each of which has at least one component, separated into two distinct parts: a graphical object and a data object. The graphical object displays on the user's screen a GUI that may be, for example, a Java Abstract Windowing Toolkit component such as for example, Panel, Frame or Component. The data object represents all the data needed to parameterize the graphical object. As such, when the data object is sent to a recipient, the recipient application can reconstruct the graphical object from the data object, and display both the graphical object and the data object. Preferably, the data object contains, among other things, the name of the Java class that represents the graphical object. At any time, the data object can be accessed from the graphical object for reading or updating purpose. An external module of the application can also access the data object.

For example, a financial calculation tool is represented by a spreadsheet user interface where the user enters their financial data, and the tool makes calculations based on the data. The graphical object is the GUI used in the financial tool (spreadsheet+calculator interface), whereas the data object represents all the financial data that the user enters, as well as the result of certain of the calculations. This may be all or some of the fit calculations.

The present invention provides an application which is composed of several GUI components, each of them corresponding to the above description.

The application has the ability to create new GUI components with which the user can interact. In order to create a new GUI component, the application preferably performs the following steps:

1. create the data object;

2. create the graphical object that renders the information contained in the data object; and

3. display the GUI component.

The two first steps can be interchanged without affecting the process. The order presented here is one possible implementation.

If the data object contains the name of the Java class that represents the graphical object, the application extracts the name, and creates the graphical object by loading and creating a new instance of this class.

Preferably, the client application contains a workspace area, where GUI components can be “dragged” and moved by user interaction. More preferably, the workspace contains a component exchanger. A component exchanger is a GUI component that allows exchange of other GUI components. When the sender “drags and drops” a GUI component onto the component exchanger, the GUI component is sent to one or more other client applications.

The list of recipients to whom the GUI component is sent is determined by the application, in accordance with the sender's choice.

The sender application can establish a connection with the server, using for example an HTTP connection, initiated by the sender. The different client applications on the network can exchange messages through the server.

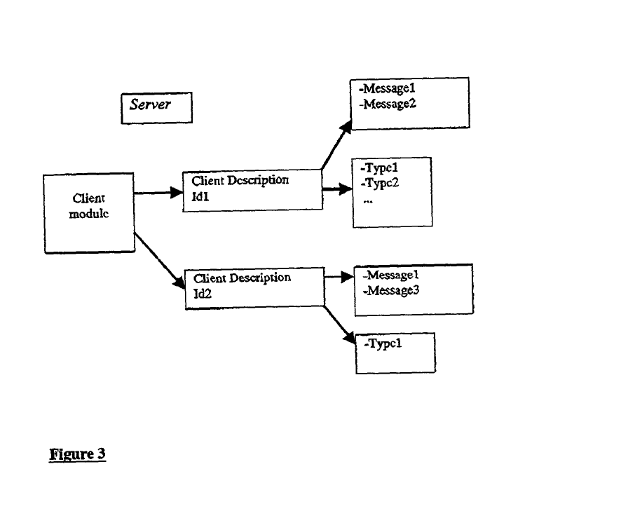

As shown in FIG. 3, there are different categories of messages that client applications can exchange. The category of the message is one or more of a number, letter, word, symbol and/or graphic, or any combination thereof, that is used by the sender's application to enable it to determine what the recipient's applications is to do with a received message. For instance, the exchange of GUI components could be a message of category 1, whereas a system message could be of category 2.

The application determines the number and nature of all possible categories, and the sender's application determines which of those is relevant for its present message. However, it is preferred that the server maintains a list of all possible categories, and checks the validity of the categories of messages that pass through it.

The first time a client connects to the server it must register with the server and is given a unique identifier. Thereafter, when a client's application starts, it logs on to the server using its unique identifier with the server. The server maintains a list of unique identifiers for all clients registered, as well as a list of those who are presently logged on. The client application specifies to the server which categories of message it is willing to receive, in response to a server request. By doing that, only messages in the categories specified by the client application will be sent to that client. At any time, the client application can register one or more a new categories of messages with the server; or can de-register one or more categories of messages. Moreover, each GUI component of the client application can register or de-register one or more categories of messages with the application. This causes the application to forward the request to the server.

For example, if the application contains a newsreader component that the user can launch, when the newsreader is launched, it causes the client application to register the category NEWS with the server (ie. the category of message corresponding to news messages). When the user terminates the newsreader, the client application de-registers the category of message NEWS from the server.

A client application may connect to the server for a number of purposes such as, or example:

to send a delivery request to the server (this may be a message to another client application);

to register or de-register a category of message with the server; and

to receive information from the server.

In each case, the identification of the client to the server can be by the use of the unique identifier of the client, which may be sent together with the request.

In the third case, the client application requests from the server the list of messages that are waiting to be delivered to the client, based on the identification sent by the client application and the categories of messages that the client application can receive.

There are at least two modes of connection to the server when the client requests the list of messages:

periodic connection: the client application connects to the server based on a frequency determined by the application. Each time it connects, the client requests new messages. If no message is available, it disconnects from the server; and

permanent connection: the client connects to the server and maintains the connection until a message is available. If the connection is broken by either party, the client re-establishes connection to the server. When the client receives a message, it closes the connection and re-connects immediately.

A delivery request sent by a client application to the server contains at least the following information:

unique identifier of the sender;

list of the unique identifiers of the intended recipients;

indication of whether the sender requires an acknowledgement of message delivery;

the category of the message; and

the message to be delivered to the other client(s): for example, a Java object.

The server uses the list of the unique identifiers of the recipients to determine which of the registered clients are to receive the message. For each registered client, the server keeps the list of message categories in which the client is interested, as well as the list of messages that the client has not yet retrieved.

Preferably, the delivery request is first converted into an XML document before being sent to the server. This ensures that the message is not language-specific and can be sent to a non-Java server and a non-Java client. To enable this step, the client will need a XML converter to convert the message into an XML document using, for example, Java Reflection.

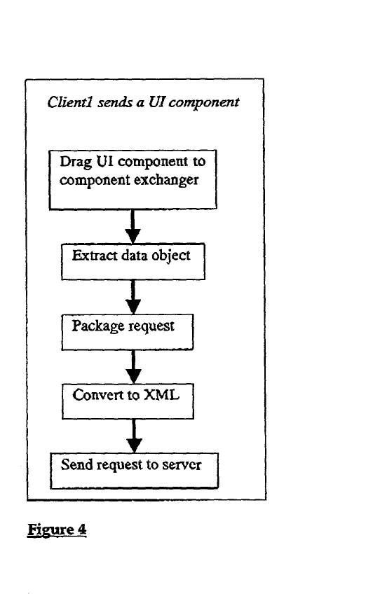

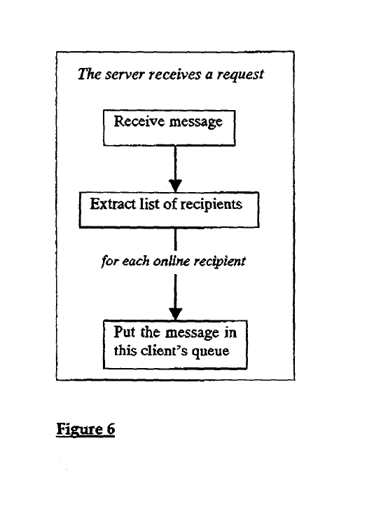

As shown in FIGS. 4 and 6, when a GUI component is sent to another client application, it can be by “dragging” the GUI component over the component exchanger. The client application accesses the data object of the GUI component, prepares a server request containing the data object as a message to be delivered to other client(s), the unique identifier of the sender, the list of client identifiers for the clients to receive the message, and the indication that the user does or does not want to receive an acknowledgement of delivery. Preferably, it converts the request into an XML document. It then connects to the server and sends the request.

In addition, or by way of alternative, other functions or methods can be used rather than the “drag and drop” method described. For example “saving” into the necessary application.

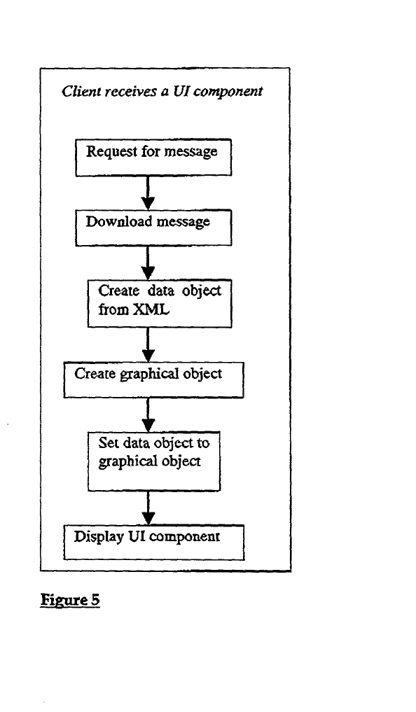

To now refer to FIGS. 5 and 6, when any of the recipients of the message connect to the server and requests new messages, they receive the message sent by the first client application.

The client application of the recipient reads the message. Preferably, the message is in form of an XML document, and the client application contains a converter that converts the XML document into a data object. By following the steps described in the previous section regarding the creation of a GUI component, the client application recreates the graphical component, and displays the graphical component, and the data component, on the screen.

When two or more client applications have exchanged GUI components, the applications can exchange update messages to all other clients that received the component. To do so, it sends a request to the server of a particular category, the list of clients to update, and the unique identifier of the client who is now the sender. At the other clients, the update message is received and the shared GUI component is updated.

For example, consider two users, user1 and user2, using an Internet browser connected to the same http server, executing the same financial application. User1 is interacting with a negotiation spreadsheet that is shared with user2 by “dragging and dropping” the spreadsheet into a transfer area of the application. User2 receives the financial spreadsheet on their application, with the data keyed in by user1. User2 then modifies the data. User1 will see the modifications in real time on his application. User1 can effect further modifications that will be seen by user1 on their application in real time. This negotiation can continue as both parties can simultaneously see the modifications that the other party makes, with “simultaneously” only being limited by any delays (inherent or otherwise) in the network.

If there are many users-such as, for example, the board of directors of a company, and if the data is a financial statement of the company, and if all users are online at the one time, they can all view and amend the data online and all users can view the amendments on their applications in real time. Therefore, draft documents and data can be finalized far more quickly, and far more effectively.

In FIG. 6 is shown that when a message reaches the server, the server first checks if the recipients are in the list of currently registered clients, or are logged on. If one or more recipients are not registered or logged on, the message cannot be delivered to them. Depending on the implementation, the server can save the message (for example, in a database or any other means), or disregard the message for those clients.

For the recipients that are in the list of registered clients, the server verifies if the category of message received corresponds to the categories of messages that the client application has registered it is willing and/or able to receive. It adds the message to the list of messages for this client. If the client has not registered for the relevant category of message but subsequently does so, the message will be delivered to them.

If the sender of the message specified in the server request that it requires an acknowledgement of delivery, the server performs a number of tasks:

if the recipient is not currently registered with the server, the server sends a message to the sender stating that the recipient could not receive the message because it is not registered;

if the recipient was registered but had not registered the category of message that was sent, the server sends a message to the sender advising that the client could not receive the category of message;

if the client was registered, has registered for this category of message, but is not logged on, the server sends a notification of successful delivery only when the message is requested and sent to the client after they logon; and

if the client is registered with the server, is registered for the category of message, and is logged on, the server sends the message to the recipient client and sends a notification of successful delivery to the sender.

When a client logs off from the server, it is removed from the list of clients who are logged on. If their details on the client database have not been changed, the client's details are not further saved. If any of the client's details have been changed, those changes are saved to the client database. Depending on the chosen implementation, the messages that had not been sent to the client are either saved (in a database, for example) or disregarded. If the messages are saved (in a database, for example) the server is able to retrieve the messages and restore the list of pending messages next time the client is logged on to the server.

Whilst there has been described in the foregoing description a preferred embodiment of the present inventions, it will be understood by those skilled in the technology that many variations in detail of the method may be changed without effecting the present invention.

The present invention extends to all features disclosed both individually as well as all possible permutations and combinations.

1. A method for exchange of data and user interface components over a network, the method including the steps of:
(a) enabling a first user to logon to a server;
(b) enabling the first user to create a message containing a data object;
(c) receiving from the first user the message together with an identity of at least one second user to whom the message is to be sent;
(d) sending the message to the second user upon the second user logging on to the server; and
(e) enabling both the first user and the second user to substantially simultaneously open and view the message including the data object.

2. A method for the exchange of data and user interface components over a network, the method including the steps of:
(a) a first user logging on to a server;
(b) the first user preparing a message containing a data object;
(c) sending the message to the server for on sending to a second user such that both the first user and the second user can substantially simultaneously open and view the message including the data object.

3. A method for the exchange of data and user interface components over a network, the method including steps of:
(a) a second user logging on to a server;
(b) the second user receiving from the server a message sent to the second user by the first user, the message containing a data object;
(c) the second user opening and viewing the message including the data object for substantially simultaneously viewing with the first user.

4. A method as claimed in claim 1, wherein the data object includes all data needed to parameterize a graphical component of the user interface such that the second user can recreate the graphical component, the data object also being a component of the user interface.

5. A method as claimed in claim 4, wherein both the first user and the second user can deal with the data object in real time such that both the first user and the second user can view the result of the dealing, the dealing with the data object being one or more selected from the group consisting of: highlighting, amending, deleting, and changing presentation as by text size, colour, font, and so forth.

6. A method as claimed in claim 1, wherein at login the first user provides a first user identifier, the first user identifier being included in the message together with a second user identifier of the second user, the first user and the second user both being registered with the server.

7. A method as claimed in claim 6, wherein the second user is a plurality of users.

8. A method as claimed in claim 1, wherein to send the message the first user drags and drops the message onto a transfer area of a graphic user interface whereupon the message is sent to the server.

9. A method as claimed in claim 6, wherein the message can be in one or more of a plurality of categories, the first user and the second user specifying those categories of messages they wish to receive when registering with the server, the server maintaining a list of all categories and, before sending the message to the second user, ensures it is of a category which the second user will receive, the message including at least one category into which the message can be classified.

10. A method as claimed in claim 2, wherein the data object includes all data needed to parameterize a graphical component of the user interface such that the second user can recreate the graphical component, the data object also being a component of the user interface.

11. A method as claimed in claim 10, wherein both the first user and the second user can deal with the data object in real time such that both the first user and the second user can view the result of the dealing, the dealing with the data object being one or more selected from the group consisting of: highlighting, amending, deleting, and changing presentation as by text size, colour, font, and so forth.

12. A method as claimed in claim 2, wherein at login the first user provides a first user identifier, the first user identifier being included in the message together with a second user identifier of the second user, the first user and the second user both being registered with the server.

13. A method as claimed in claim 12, wherein the second user is a plurality of users.

14. A method as claimed in claim 2, wherein to send the message the first user drags and drops the message onto a transfer area of a graphic user interface whereupon the message is sent to the server.

15. A method as claimed in claim 12, wherein the message can be in one or more of a plurality of categories, the first user and the second user specifying those categories of messages they wish to receive when registering with the server, the server maintaining a list of all categories and, before sending the message to the second user, ensures it is of a category which the second user will receive, the message including at least one category into which the message can be classified.

16. A method as claimed in claim 3, wherein the data object includes all data needed to parameterize a graphical component of the user interface such that the second user can recreate the graphical component, the data object also being a component of the user interface.

17. A method as claimed in claim 16, wherein both the first user and the second user can deal with the data object in real time such that both the first user and the second user can view the result of the dealing, the dealing with the data object being one or more selected from the group consisting of: highlighting, amending, deleting, and changing presentation as by text size, colour, font, and so forth.

18. A method as claimed in claim 3, wherein at login the first user provides a first user identifier, the first user identifier being included in the message together with a second user identifier of the second user, the first user and the second user both being registered with the server.

19. A method as claimed claim 18, wherein the second user is a plurality of users.

20. A method as claimed in claim 3, wherein to send the message the first user drags and drops the message onto a transfer area of a graphic user interface whereupon the message is sent to the server.

21. A method as claimed in claim 18, wherein the message can be in one or more of a plurality of categories, the first user and the second user specifying those categories of messages they wish to receive when registering with the server, the server maintaining a list of all categories and, before sending the message to the second user, ensures it is of a category which the second user will receive, the message including at least one category into which the message can be classified.
